(19) United States
(12) Patent Application Publication
(10) Pub. No.: US 2012/0215368 A1
(43) Pub. Date: Aug. 23, 2012

(54) STORAGE INTEGRATED MANAGEMENT SYSTEMS FOR ENERGY MICROGRIDS

(75) Inventor: Ratnesh Sharma, Fremont, CA (US)

(73) Assignee: NEC LABORATORIES AMERICA, INC., Princeton, NJ (US)

(21) Appl. No.: 13/339,201

(22) Filed: Dec. 28, 2011

Related U.S. Application Data
(60) Provisional application No. 61/445,670, filed on Feb. 23, 2011.

(51) Int. Cl. G06F 1/26

(52) U.S. Cl. 700/287; 700/297

(57) ABSTRACT

Systems and methods are provided to manage power storage, by generating power with one or more microgenerators; charging an ensemble of energy storage devices to receive power from the one or more microgenerators; abstracting the ensemble of storage resources with different characteristics, a dynamic and a current model of the load, and user-defined policies for operation, and matching a demand profile with a predetermined mix of energy supply from storage devices.

This application claims priority to Provisional Application Ser. No. 61/445,670 filed Feb. 23, 2011, the content of which is incorporated by reference.

### BACKGROUND

The present invention relates to storage-integrated management systems for energy microgrids.

A smart grid is an interconnected system of information and communication technologies and electricity generation, transmission, distribution and end-use technologies that promise to enable consumers to manage their usage and choose the most economically efficient offering, maintain delivery system reliability and stability enhanced by automation, and use the most environmentally benign generation alternatives including renewable resources and energy storage.

Energy microgrids are a key building block of smart grids. Energy microgrids can not only provide voltage and VAR support to the power grid but also reduce the emission footprint of the overall power generation infrastructure. While it provides added advantages like grid decongestion and reduced operating cost for system operators, it creates significant challenges in stable operation and meeting economic goals of the microgrid owners. Currently, energy microgrids are heavily subsidized through government grants/rebates and require high maintenance in terms of skilled operating staff and advance control systems.

A microgrid is a group of interconnected loads and distributed energy resources within clearly defined boundaries that act as a single controllable entity with respect to the grid. A microgrid can connect and disconnect from the grid to enable it to operate in both grid-connected or island mode. In this context, distributed energy resources (DER)—small power generators typically located at users' sites where the energy (both electric and thermal) they generate is used—have emerged as a promising option to meet growing customer needs for electric power with an emphasis on reliability and power quality. The portfolio of DER includes generators, energy storage, load control, and, for certain classes of systems, advanced power electronic interfaces between the generators and the bulk power provider. Maintaining this profile relies on the flexibility of advanced power electronics that control the interface between microsources and their surrounding AC system.

Energy storage enables the decoupling of energy supply from energy demand. This is of particular importance since electricity demand is subject to substantial hourly, daily and seasonal variations. Also, electricity supply, particularly from renewable sources, is also subject to significant variability, both short term (over a few seconds) and longer term (e.g. hourly, daily, seasonal). In addition, storage has other emerging benefits like being dispatchable as spinning reserves, providing voltage/VAR support in the distribution network. When power system disturbances occur, synchronous generators are not always able to respond rapidly enough to keep the system stable. If high-speed real or reactive power control is available, load shedding or generator dropping may be avoided during the disturbance. High speed reactive power control is possible through the use of flexible ac transmission systems (FACTS) devices. However, a better solution would be to have the ability to rapidly vary real power without impacting the system through power circulation. This is where energy storage technology can play a very important role in maintaining system reliability and power quality. The ideal solution is to have means to rapidly damp oscillations, respond to sudden changes in load, supply load during transmission or distribution interruptions, correct load voltage profiles with rapid reactive power control, and still allow the generators to balance with the system load at their normal speed. Among others, possible benefits include: transmission enhancement, power oscillation damping, dynamic voltage stability, tie line control, short-term spinning reserve, load leveling, under-frequency load shedding reduction, circuit break reclosing, sub synchronous resonance damping, and power quality improvement. Energy Storage has other benefits like deferment of new generation, transmission and distribution equipment, but we will restrict ourselves to microgrid needs for purposes of the paper.

In microgrids various forms of energy storage are possible including thermal, chemical and mechanical. Being close to demand offers unique opportunity to store various forms of energy.

Ultracapacitors (also known as supercapacitors or EDLCs) are double layer capacitors that increase energy storage capability due to a large increase in surface area through use of a porous electrolyte (they still have relatively low permittivity. and voltage-withstand capabilities) [15]. Several different combinations of electrode and electrolyte materials have been used in ultracapacitors, with different combinations resulting in varying capacitance, energy density, cycle-life, and cost characteristics. At present, ultracapacitors are most applicable for high peak-power, low-energy situations. Capable of floating at full charge for ten years, an ultracapacitor can provide extended power availability during voltage sags and momentary interruptions. Ultracapacitors can be stored completely discharged, installed easily, are compact in size, and can operate effectively in diverse (hot, cold, and moist) environments.

Flywheels can be used to store energy for power systems when the flywheel is coupled to an electric machine. In most cases, a power converter is used to drive the electric machine to provide a wider operating range. Stored energy depends on the moment of inertia of the rotor and the square of the rotational velocity of the flywheel. Two strategies have been utilized in the development of flywheels for power applications. One option is to increase the inertia by using a steel mass with a large radius, with rotational velocities up to approximately 10,000 rpm. The lightweight rotor can turn at very high rotational velocities (up to 100,000 rpm). This approach results in compact, lightweight energy storage devices. Modular designs are possible, with a large number of small flywheels possible as an alternative to a few large flywheels

Batteries are one of the most mature energy storage technologies available, with energy stored electrochemically. A battery system is made up of a set of low-voltage/power battery modules connected in parallel and series to achieve a desired electrical characteristic. Batteries store dc charge, so power conversion is required to interface a battery with an ac system. Small, modular batteries with power electronic converters can provide four-quadrant operation (bidirectional current flow and bidirectional voltage polarity) with rapid response. Due to the chemical kinetics involved, batteries cannot operate at high power levels for long time periods. In addition, rapid, deep discharges may lead to early replacement of the battery, since heating resulting in this kind of operation reduces battery lifetime. Key factors of batteries for storage applications include high energy density, high energy capability, round trip efficiency, cycling capability, life span, and initial cost. Energy storage cost is a function of the storage device power and energy capacities and their specific costs depending on chosen technology.

Other forms of energy storage in form of biogas from landfill or digesters or hot water from waste heat of generation units are also well suited for microgrids.

### SUMMARY

In one aspect, an energy storage management system (ESMS) manages an energy storage ensemble with one or more storage devices for base load, peak load and instantaneous loads.

In another aspect, systems and methods are provided to manage power storage, by generating power with one or more microgenerators; charging an ensemble of energy storage devices to receive power from the one or more microgenerators; abstracting the ensemble of storage resources with different characteristics, a dynamic and a current model of the load, and user-defined policies for operation, and matching a demand profile with a predetermined mix of energy supply from storage devices.

Advantages of the preferred embodiments may include one or more of the following. The energy storage management system monitors microgrid generation, demand and grid parameters. The system acts appropriately to deliver services like load leveling, voltage/frequency stability, among others. The system addresses the high cost of ownership of energy microgrids while retaining the advantages of reduced emissions and resource consumption. The energy storage also offers unique opportunities in simplifying the control system of such distributed generation infrastructure and improving the reliability of microgrid in meeting local demand constraints. The microgrid energy storage system addresses the high cost of ownership of energy microgrids while retaining the advantages of reduced emissions and resource consumption. Energy storage also offers unique opportunities in simplifying the control system of such distributed generation infrastructure and improving the reliability of microgrid in meeting local demand constraints.

### BRIEF DESCRIPTION OF THE DRAWINGS

FIG. 1 shows an exemplary system for managing power flow in a smart grid.

FIG. 2 shows an exemplary demand profile.

FIG. 3 shows an exemplary maximum load duration curve.

FIG. 4 shows an exemplary actual load duration curve.

FIG. 5 shows an exemplary energy storage management system.

FIG. 6 shows an exemplary wind generation output.

FIG. 7 shows an exemplary depth of discharge for batteries.

FIG. 8 shows an exemplary flow chart for off-peak generation.

FIG. 9 shows an exemplary computer system for managing smart-grid power.

### DESCRIPTION

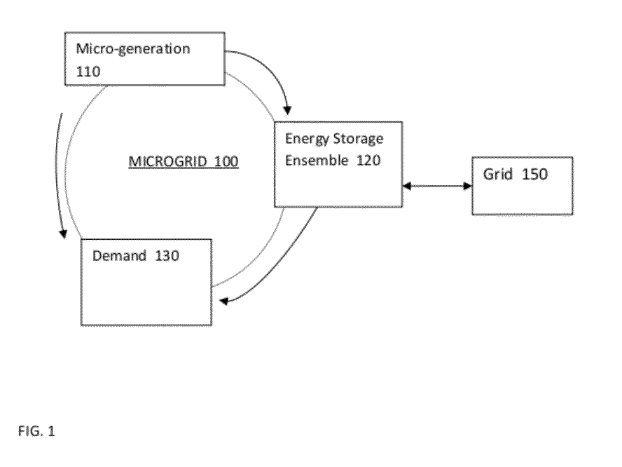

FIG. 1 shows an exemplary system for managing power flow in a smart grid. The system of FIG. 1 includes a microgrid 100. In the power flows of FIG. 1, the microgrid 100 is powered by a micro-generation system 110 that charges an energy storage ensemble 120 which in turn serves a load or demand 130. The energy storage ensemble 120 can interact with a grid 150 such as a smart grid, for example.

The energy storage ensemble 120 includes a combination of storage devices for base load, peak load and instantaneous loads managed by an energy storage management system (ESMS). The energy storage management system monitors microgrid generation, demand and the grid parameters. The management system acts appropriately to deliver services like load leveling, voltage/frequency stability, among others.

The management system has various functions, one of which may be to act as a “dispatch” as well as manage the state of the storage devices and operate storage ensemble based on externalities such deficit in generation and demand characteristics. During critical events, the management system can assess the health of local energy storage and disconnect from the grid, operating in islanded mode for certain period of time.

The storage devices vary in performance, efficiency and lifespan. Matching individual device characteristics to generation-demand profiles is challenging, and can at best be approximate. Moreover, multiple storage devices may be capable of responding to any deficit in generation or surge in demand with considerably different impact on lifecycle, reliability and cost. Also similar considerations will determine time, level and rate of charging. Hybrid energy storage systems have been proposed in the past combining the power output of two or more devices with complementary characteristics like high-power devices (devices with quick response) and high-energy devices (devices with slow response) but they have never operated and managed as an ensemble. The performance of the storage ensemble should scale with demand in the microgrid and be flexible enough to exploit energy exchange with the grid.

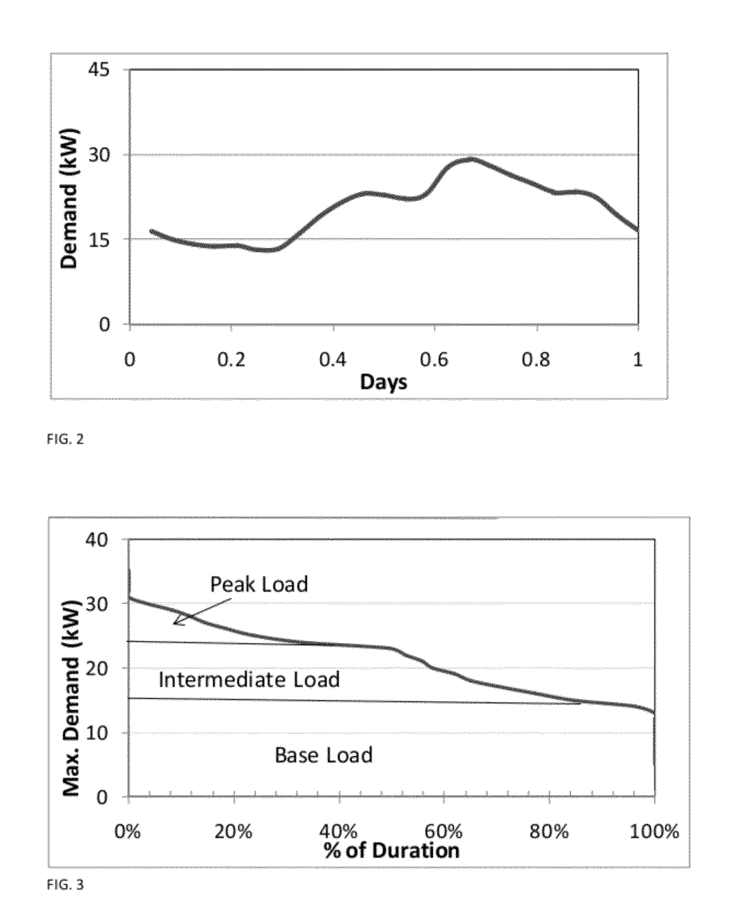

FIG. 2 shows an exemplary demand profile of a typical building microgrid. The load doubles during the day. Seasonal variations, not shown in the profile, may occur. The storage systems can be designed around the demand curve alone or the combination of demand and generation. For purpose of the paper we consider the demand profile as the storage demand profile. Other considerations can be handled as well.

As a first step, classification of demand is essential. FIG. 3 shows an exemplary maximum load duration curve (LDC) for a typical building microgrid. The y-axis shows the maximum demand while the x-axis shows the percent of time spent below the demand level.

In this case, demand can be segmented into base load, intermediate load and peak load. Initial selection of storage device and appropriate technology can be based on such curves. If the storage system is expected to provide spinning reserves, the demand curve in FIG. 2 can be raised further. The maximum usage and energy demand also provide an estimate of capacity utilization in an existing system. However, knowledge of typical load duration may be necessary to size each device. FIG. 3 shows one such curve.

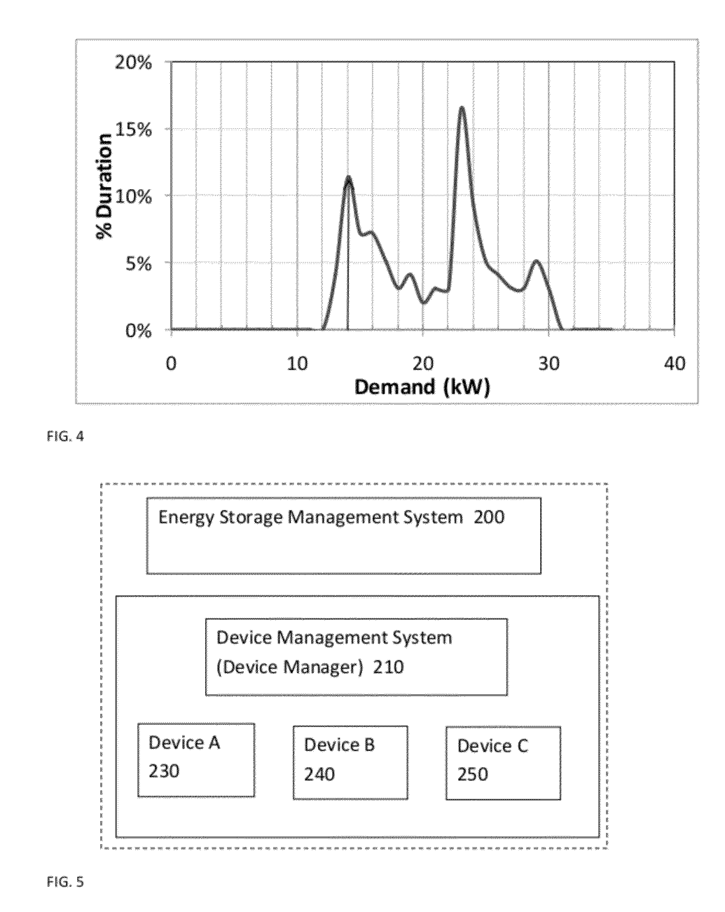

FIG. 3 shows an exemplary maximum load duration curve, while FIG. 4 shows an actual load duration curve. In this example, a normal demand is always over 12 kW and the peak is above 30 kW, as indicated by FIG. 2 as well. Also, two peaks exist in the demand duration profile, namely, 14 kW and 23 kW. The area under the curve can be used to estimate the energy demand as well. Based on the time horizon, peak energy demand can be estimated. The peak energy demand and allowable maximum depth of discharge can be used to estimate the lower bound of storage size and the technology itself. Having said that instantaneous demand profile must be considered to obtain the desired ramp rate and size the storage system based on power draw.

Turning now to the Energy Storage Management system, the system matches the demand profile with the suitable mix of energy supply from storage devices. The system consists of abstraction of storage resources with different characteristics, a dynamic and current model of the load and user-defined policies for operation. The functional characteristics key to design of the system include ramp rate, peak power and energy per cycle, cycle life, cost of ownership and round trip efficiency, among others. Operational modes determine the trade-off policies between efficiency, cycle life, cost of ownership and performance.

FIG. 5 shows a schematic representation of a storage management system 200. The storage management system 200 is designed for certain services like peak shaving or energy arbitrage. The system 200 includes a device management system 210 that handles devices 230-250. The sizing and selection of storage devices 230-250 vary with kind and reliability of service. In one embodiment, the management system 210 includes model of the storage devices 230-250, their current state of health and operational policies. The state of health of a storage device 230-250 provides the expected working lifetime while the model helps in operation of the right device from the ensemble for the service. The policies determine the suitability of certain devices for the application and helps to quantify the lifetime impact on the device as well cost of providing the service. The device model includes a characteristic charging-discharging curves, roundtrip losses, expected cycle lifetime and cost curves. The device management system, primarily, maintains the health of device and safety. The storage management system acts as a dispatchable source in the microgrid.

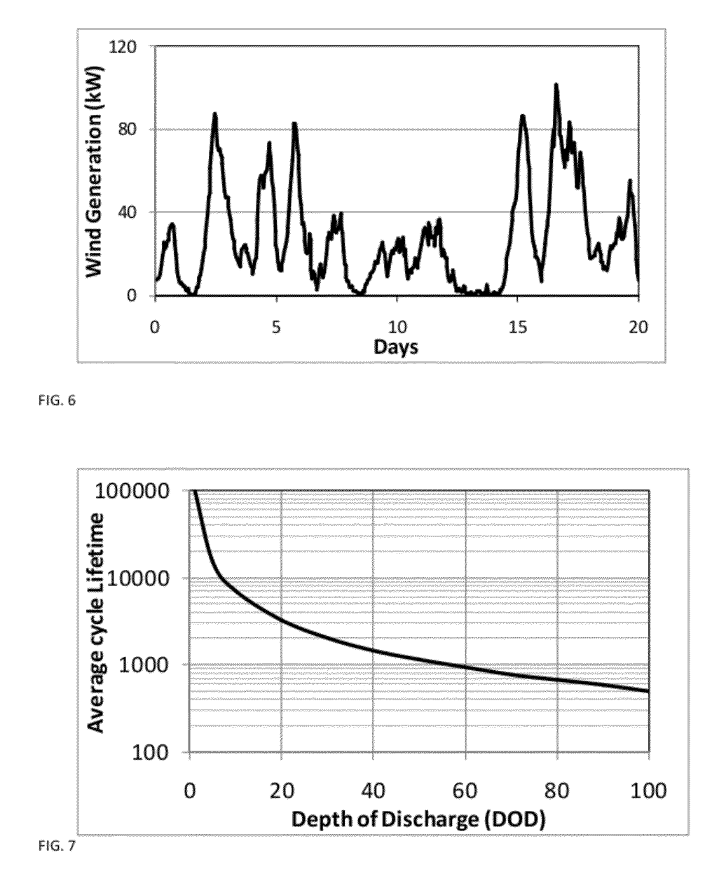

The system increases renewable energy penetration. Although renewable energy sources are environmentally beneficial, the intermittent nature of two fast growing energies, wind and solar, causes voltage and frequency fluctuations on the grid. It is estimated that, for every 10% wind penetration, a balancing power from other generation sources equivalent to 2-4% of the installed wind capacity is always required for a stable power system operation. FIG. 6 shows the stochastic output of wind generation system following a Weibull distribution. Energy storage systems can provide ancillary services in such cases to even out injection/absorption of power from stochastic generation through monitoring of voltage/frequency droop/surges. Ultracapacitors may be suited for short term events, while batteries can provide adequate support for longer term events.

The system can also provide load leveling. Load leveling refers to the use of electricity stored during times of low demand to supply peak electricity demand, which reduces the need to draw on electricity from peaking power plants or increase the grid infrastructure [8]. FIG. 2 indicated that peak loads were double that of off-peak load indicating that in the absence of storage, micro-generation should follow load. This implies need of advanced controls at the generation source. Ideally, flow (or NaS) batteries have high inertia and can fulfill this need without advanced controls.

Energy Arbitrage can also be done. Energy arbitrage refers to earning a profit by charging storage system with cheap electricity when demand is low and selling the stored energy at a higher price when demand is high. This activity can also be used to influence in the demand side, such as using higher peak prices to induce a reduction in peak demand through demand charges, real time pricing, or other market measures.

In order to get the highest profit of energy prices differences between light-load and peak-load periods, energy storage charge/discharge operation must be scheduled such as, to store low-price energy during light-load periods and then to deliver it during peak-load ones. Benefits can be made only if storage system efficiency is greater than the ratio (off-peak energy price/peak energy price). The system can also provide Primary Frequency Regulation. Frequency regulation in the microgrid is another important function, storage systems may be called upon to provide. This may include transient and permanent frequency stability, through injection and absorption of real power during short periods of time, 1 to 2 seconds. As an example, this application may be more relevant to frequency stability of islanded microgrids. Modern variable speed wind turbines and large photovoltaic power plants connected to the utility grid do not contribute to the frequency stability unlike synchronous generators of the conventional gas or steam turbine. This creates a new application of storage systems to emulate the inertia of these steam turbines generators to complement the deficit in angular stability. The control can be achieved using a power factor constraint like where is the phase angle, to deliver a certain level of reactive power. Integration of FACTS devices in storage systems can provide independent real and reactive power absorption/injection into/from the grid, therefore improving system reliability and enhancing power quality. Based on power factor and frequency constraint, storage systems can provide ancillary services. Benefits can be estimated by considering the total costs of avoided equipment or the cost of power quality disturbances like long period interruptions (blackouts), short period interruptions (voltage sags) voltage peaks and variable fluctuation (flicker).

The system can handle peak shaving. The primary benefit of peak shavings is to reduce investment on upgrades and help with energy arbitrage. The goal is to reduce peak energy consumption (see FIG. 2) below a threshold. A dispatchable storage source can be committed to deliver power during this period and reduce the peak. The system can capture the incremental cost of using storage as well.

The system maximizes efficiency. Round trip efficiencies for different storage technologies can vary between 60 to 90%. In most cases, it is a function of depth of discharge as well. The storage management system must consider the conversion efficiency of the generation sources and the conversion losses to evaluate the overall efficiency of providing electrical power.

ηᵢ=fᵢ(DOD,T)

where i, is the index for specific storage technology, DOD is the depth of discharge and T is the temperature.

The system can maximize the life of storage devices. The life of storage devices varies with cycle depth. As a first order, tracking the number and depth of discharges, particularly cumulative ampere-hours removed, can be useful in assessing the state of health of storage device. FIG. 7 shows the variation with depth of discharge (DOD) for a typical Li-ion battery. Expected cycle lifetime is not allowed to drop below a certain minimum which is calculated based on a battery lifetime constraint. As mentioned before, lifetime curves are a part of the model within the storage management system and help assess the availability of the storage device.

FIG. 8 shows a simplified flow chart of operation during off-peak time of use. First, state information from the grid, microgeneration sources and the demand bus are collected (510). The process also measures demand parameters (520) as well as storage device parameters (530). This mostly comprises of bus voltage, frequency and PQ (real and reactive power) characteristics. The price of use/sale of power from the grid is set. Pmin is the cost of producing power in the microgrid. A state of charge (SOC) is used in the estimate of health of the storage system. In reality, this will include parameters from multiple storage devices and the expected demand from each. Cmin is considered as a critical limit for the state of health of the storage system.

As before, there may be several such limits in practice for different devices based on the device model. The device management system will provide this state of health information. As an example, an ultracapacitor may be 50% discharged but still function as expected unlike a battery.

The state of charge is assessed (540). If the SOC is greater than Cmin (550), then the process performs energy arbitration (560), and otherwise the storage systems are charged (570). The storage systems are charged if the state of charge is below a critical limit. Energy arbitration is also done if the SOC is less than 100%.

If price to produce power is lower than the asking price from grid, energy arbitrage is possible (542). Otherwise charging is the only recommended course of action.

Services like charging, energy arbitrage, peak shaving, ancillary services and others can be added. Also, policies like maximizing life and efficiency, reduction in emissions, maximizing performance or return on investment can be implemented while executing the services.

The following is a list of functions that one embodiment of an intelligent storage management system can carry out in its broader role as a microgrid management system.
1. Connect/Disconnect from Grid based on IEEE 1547 events or else.
2. Adjust Maximum Generation Level from each microgeneration source based on cost of generation, reliability, emissions and efficiency
3. Adjust Power Factor with target value and ramp rate with delays
4. Regulate frequency in the microgrid
5. Request change in real and active power levels from microgenerators
6. Provide indication of price to decide on charge and discharge of storage and other cost driven functions
7. Receive pricing signal from the grid to decide on operation of storage, generation and demand
8. Maintain log of history of events and current status
9. Maintain time synchronization with the grid
10. VAR support modes including energy conservation, maximum support, fixed or grid follower mode.
11. Perform the above mentioned tasks actively or on a scheduled basis. (time, temperature or pricing)

The intelligent storage management system will have performance metrics based on standby efficiency, storage efficiency, speed of response and pulse power delivery.

Based on the metrics and functions, the operation of the storage-integrated management system from a storage perspective can be categorized into various modes:
1. Load management mode—Storage system could discharge at varying levels according to a control signal. The system could calculate the required discharge relative to a remotely-set threshold value.
2. Frequency regulation mode—System(s) could charge or discharge in response to signals received approximately every second. The goal is to maintain a target state of charge (such as 60%) over the long run while supporting frequency.
3. Constant power charge/discharge mode—(set storage performance)
4. Reactive power mode (manage VARs with various objectives)—designed to source or sink reactive power. This mode could be included power charge or power discharge mode.
5. Self-directed charge (or maintenance) mode—System can charge according to its own optimum method to reach a defined ready state at a defined time.
6. Self-maintenance mode (perform conditioning)
7. Standby/Shutdown mode.
8. Islanding mode—Detect abnormal utility conditions or open contactor and serve customers in an island (ref. IEEE P1547.4). Resynchronize and reconnect when the utility is restored.
a. Quick transition mode (immediate shift)
b. Intended or adjustable time-delayed transition mode (shift based on time delay to allow microgenerators to respond.

The energy storage management system monitors microgrid generation, demand and the grid parameters. The system acts appropriately to deliver services like load leveling, voltage/frequency stability, among others. The system addresses the high cost of ownership of energy microgrids while retaining the advantages of reduced emissions and resource consumption. Energy storage also offers unique opportunities in simplifying the control system of such distributed generation infrastructure and improving the reliability of microgrid in meeting local demand constraints. The microgrid energy storage system addresses the high cost of ownership of energy microgrids while retaining the advantages of reduced emissions and resource consumption. Energy storage also offers unique opportunities in simplifying the control system of such distributed generation infrastructure and improving the reliability of microgrid in meeting local demand constraints.

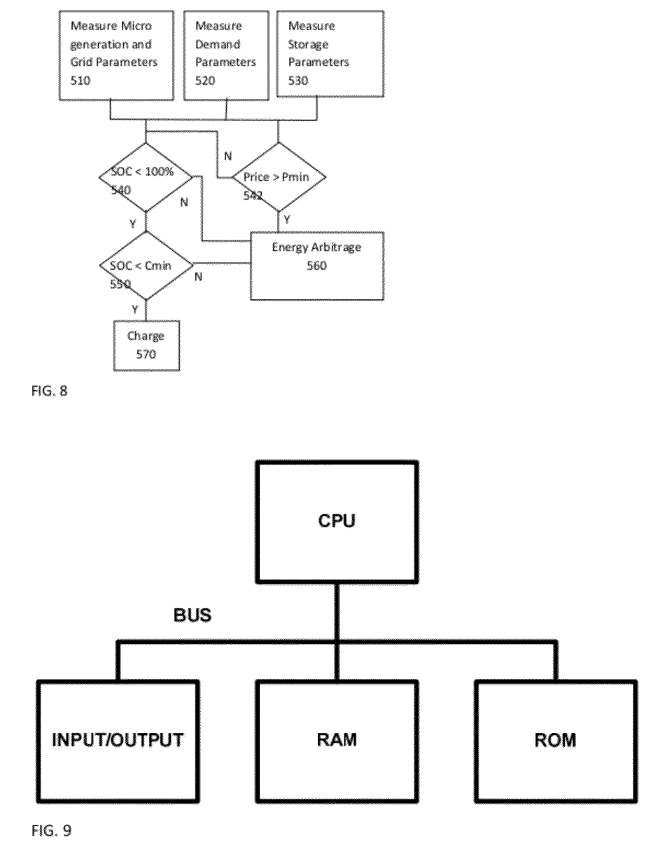

FIG. 9 shows an exemplary computer system for managing smart-grid power. While various embodiments of the present invention have been described above, it should be understood that they have been presented by way of example only, and not of limitation. Likewise, the various diagrams may depict an example architectural or other configuration for the invention, which is done to aid in understanding the features and functionality that may be included in the invention. The invention is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the present invention. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and may further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention.

Although the invention is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments. Thus, the present invention is not intended to be limited to the embodiments shown herein but is to be accorded the widest scope consistent with the principles and novel features disclosed herein.

What is claimed is:

1. An energy management system, comprising:
one or more microgenerator(s);
an ensemble of energy storage devices to receive power from the one or more microgenerator(s) or the grid; and
a device manager coupled to the ensemble of storage devices, wherein the device manager stores an abstraction of the ensemble of storage resources with different characteristics, a dynamic and a current model of the load, and user-defined policies for operation, and wherein the controller matches a demand profile with a predetermined mix of energy supply from storage devices.

2. The system of claim 1, wherein the device manager models ramp rate, peak power and energy per cycle, cycle life, cost of ownership and round trip efficiency.

3. The system of claim 1, wherein the device manager comprises operational modes including trade-off policies between efficiency, cycle life, cost of ownership and performance.

4. The system of claim 1, wherein the device manager determines conversion efficiency of providing electrical power as
ηᵢ=fᵢ(DOD,T)
where i is an index for a specific storage technology, DOD is the depth of discharge and T is temperature.

5. The system of claim 1, wherein the user defined policies determine the suitability of certain devices for an application and quantify a lifetime impact on the device and cost of providing energy.

6. The system of claim 1, wherein the storage devices support base load, peak load, and instantaneous load.

7. The system of claim 1, wherein the device manager provides load leveling and voltage/frequency stability.

8. The system of claim 1, wherein the device manager maintains energy storage device health and safety.

9. The system of claim 1, wherein the device manager controls the energy storage devices as a dispatchable source in a microgrid.

10. The system of claim 1, wherein the device manager assesses the energy storage device health and disconnects the energy storage device from a grid, and operates the energy storage device in an islanded mode for certain period of time.

11. A method to manage power storage, comprising
generating power with one or more microgenerators;
charging an ensemble of energy storage devices to receive power from the one or more microgenerators;
abstracting the ensemble of storage resources with different characteristics, a dynamic and a current model of the load, and user-defined policies for operation, and
matching a demand profile with a predetermined mix of energy supply from storage devices.

12. The method of claim 11, comprising modeling ramp rate, peak power and energy per cycle, cycle life, cost of ownership and round trip efficiency.

13. The method of claim 11, operating the energy storage devices with trade-off policies between efficiency, cycle life, cost of ownership and performance.

14. The method of claim 11, comprising determining conversion efficiency of providing electrical power as
ηᵢ=fᵢ(DOD,T)
where i is an index for a specific storage technology, DOD is the depth of discharge and T is temperature.

15. The method of claim 11, comprising applying user defined policies to determine the suitability of certain devices for an application and quantify a lifetime impact on the device and cost of providing energy.

16. The method of claim 11, wherein each energy storage devices include a base load, peak load, and instantaneous load.

17. The method of claim 11, further comprising assessing the energy storage device health and disconnects the energy storage device from a grid, and operating the energy storage device in an islanded mode for certain period of time.

18. The method of claim 11, wherein the device manager provides load leveling and voltage/frequency stability.

19. The method of claim 11, wherein the device manager maintains energy storage device health and safety.

20. The method of claim 11, wherein the device manager controls the energy storage devices as a dispatchable source in a microgrid.
